(19) United States
(12) Patent Application Publication
(10) Pub. No.: US 2003/0172060 A1
(43) Pub. Date: Sep. 11, 2003

(54) Information retrieval-distribution system

(76) Inventor: Makoto Uchikado, Takatsuki (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/340,673

(22) Filed: Jan. 13, 2003

(30) Foreign Application Priority Data
Mar. 11, 2002 (JP) 2002-064740

(51) Int. Cl. G06F 7/00

(52) U.S. Cl. 707/3

(57) ABSTRACT

A retrieval and distribution server 10 connected to a plurality of user terminals 4 has a function of retrieving information from a Web server 1 in accordance with retrieval conditions designated by users, and distributing the retrieved information to respective user terminals at pre-designated time, and a function of selecting information to be open in accordance with a predetermined bulletin condition among from the retrieved information and transferring the selected information to a bulletin board server 6.

### BACKGROUND OF THE INVENTION

1. Field of the Invention

The present invention relates to an information retrieval-distribution system and, more particularly, to an information retrieval-distribution system connected to a computer network to which a plurality of user terminals are connected and a communication network to which various kinds of information providing servers are connected, for accessing the information providing servers instead of user terminals, and distributing retrieval results to the user terminal as a requester.

2. Description of Related Art

A technique, like a Web server on the Internet, of retrieving information provided by a computer connected to a communication network in accordance with pre-designated retrieval conditions and distributing the result of the retrieval to the user as a requester by an e-mail is disclosed in, for example, Japanese Unexamined Patent Publication No. 9-153050 which corresponds to U.S. Pat. No. 5,893,114.

According to the prior art, for example, the latest information matching the retrieval conditions designated in advance by the user can be periodically selected among from information which is updated every moment and provided from a Web server, and distributed by an e-mail at time designated by the user.

### SUMMARY OF THE INVENTION

The Prior art has a problem such that when the amount of distributed information of each time becomes large, it becomes difficult for the user to read all of distributed information. According to the prior art., information distribution service by using an e-mail is provided to a specific user who has reserved retrieval and distribution in advance. For an indefinite number of users who have not requested retrieval and distribution, information service in the form of putting the latest information in fields related to the users on public view at any time by a simple user operation cannot be provided.

An object of the present invention is to provide an information retrieval and distribution system capable of providing service of distributing information to a plurality of users according to retrieval and distribution conditions pre-designated to each user and opening the latest information common to a group of unspecified users at any time to the group.

Another object of the invention is to provide an information retrieval and distribution system capable of easily discriminating information which is important to a user among from information distributed to the user.

To achieve the object, the present invention provides an information retrieval and distribution system connected to a computer network including a plurality of user terminals and a communication network to which various information providing servers are connected, for accessing the information providing servers instead of the user terminals, comprising: retrieval and distribution processing means for accepting a request of retrieval and distribution of information from any of the user terminals, retrieving information from any of the information providing servers in accordance with a retrieval condition designated by the user, and distributing the retrieved information to the user terminal as the requester at pre-designated time; and bulletin information processing means for selecting information to be disclosed in accordance with a predetermined posting condition among from retrieval results based on the retrieval and distribution request and transferring the selected information to an electronic bulletin board system connected to the computer network.

Specifically, in the information retrieval and distribution system according to the invention, the bulletin information processing means selects overlapping information in retrieval results of a plurality of users designated as a group by the bulletin conditions and transfers the selected information to the electronic bulletin board system as public information. As the bulletin conditions, for example, a bulletin board address and posting time are designated. The bulletin information processing means selects information among from retrieval results of a plurality of users designated as the group and transfers the selected information as information to be posted on an electronic bulletin board specified by the bulletin board address to the bulletin board system at the posting time designated by the bulletin conditions.

With the configuration, for example, by grouping a plurality of users who have requested for retrieval and distribution on a section unit basis in a company, overlapping information in retrieval results of the plurality of users can be selected as open information for each section and posted on an electronic bulletin board for the section. Therefore, each of members in a company can always refer to common information included in the latest information retrieved by other members in the same section by accessing the electronic bulletin board for the section to which the user belongs.

Another feature of the invention resides in that the retrieval and distribution means stores importance judging information of retrieved information in association with the retrieval and distribution conditions and has means for determining the degree of importance of each information item retrieved according to the retrieval and distribution condition in accordance with the importance judging information and distributing the retrieved information to the user terminal as a requester in a form in which a result of judging the degree of importance is added. With the configuration, even when a large amount of information is distributed, by determining the necessity of reference in accordance with the degree of importance added to each retrieved information item, the user can efficiently grasp the latest trend in short time.

### BRIEF DESCRIPTION OF THE DRAWINGS

FIG. 1 is a diagram showing an example of a computer network including a retrieval and distribution server 10 of the invention.

FIG. 2 is a diagram showing an example of a retrieval and distribution conditions table 21 in FIG. 1.

FIG. 3 is a diagram showing an example of an importance judging information table 23 in FIG. 1.

FIG. 4 is a diagram showing an example of a bulletin distribution condition table 25 in FIG. 1.

FIG. 5 is a diagram showing an example of a retrieved data management table 270 formed in a retrieved data file 27 in FIG. 1.

FIG. 6 is a diagram showing an example of a retrieved data table 280 formed in the retrieved data file 27 in FIG. 1.

FIG. 7 is a diagram showing an example of a retrieval result distribution message of a normal type transmitted to a user terminal.

FIG. 8 is a diagram showing an example of a retrieval result distribution message of an omission type transmitted to a user terminal.

FIG. 9 is a diagram showing an example of information opened on a bulletin board by a bulletin board server 6 in FIG. 1.

FIG. 10 is a flowchart showing an example of a retrieval and distribution conditions input routine 100 executed by the retrieval and distribution server 10.

FIG. 11 is a flowchart showing an example of a bulletin distribution condition input routine 120 executed by the retrieval and distribution server 10.

FIG. 12 is a flowchart showing an example of a main control routine 130 for retrieval and distribution service executed by the retrieval and distribution server 10.

FIG. 13 is a flowchart showing an example of a retrieval routine 150 executed by the retrieval and distribution server 10.

FIG. 14 is a flowchart showing an example of an importance judging routine 160 executed by the retrieval and distribution server 10.

FIG. 15 is a flowchart showing an example of a bulletin distribution routine 170 executed by the retrieval and distribution server 10.

FIG. 16 is a flowchart showing an example of a retrieved data distribution routine 190 executed by the retrieval and distribution server 10.

### DESCRIPTION OF THE PREFERRED EMBODIMENTS

An embodiment of the invention will be described in detail hereinbelow with reference to the drawings.

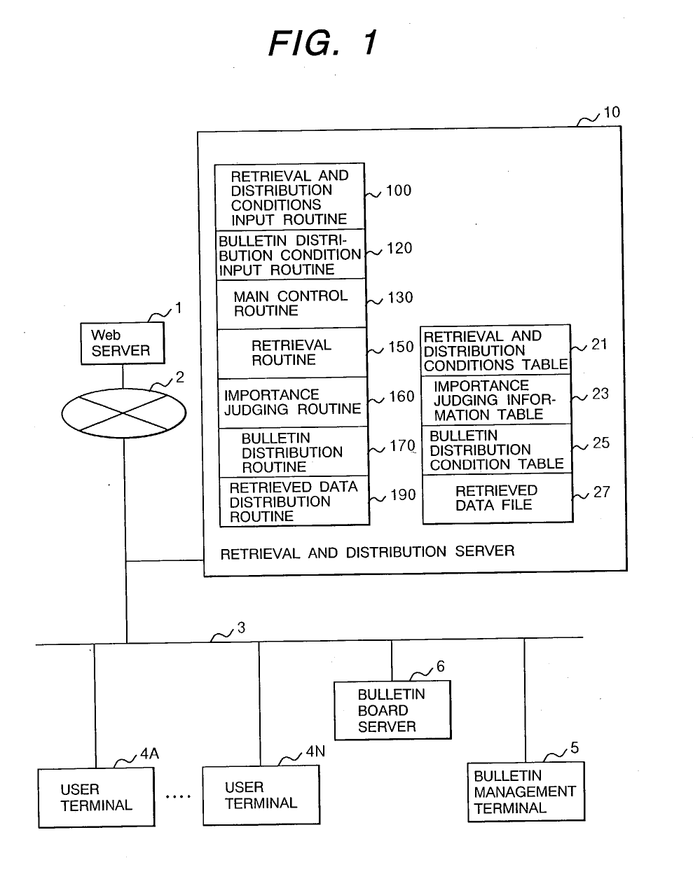

FIG. 1 shows an example of a computer network including a retrieval and distribution server 10 according to the invention.

The retrieval and distribution server 10 is connected to a Web server 1 via a communication line and the Internet 2 and connected to a plurality of user terminals 4 (4A to 4N), a bulletin management terminal 5, and a bulletin board server 6 via an LAN 3. To the Internet 2, various Web servers represented by the Web server 1 are connected. The Web server 1 stores document information, for example, news and articles updated every day every moment and provides the retrieved information to various computers connected via the Internet 2.

The retrieval and distribution server 10 receives a retrieval and distribution request in which retrieval conditions, retrieval time, and distribution time are designated from each of the user terminals 4 connected to the LAN 3, accesses the Web server 1 at time designated by the retrieval and distribution request, and retrieves information matching the designated retrieval conditions. The result of retrieval obtained from the Web server 1 is temporarily stored in the retrieval and distribution server 10 and distributed to the user terminal as a requester at the distribution time designated by the retrieval and distribution request.

One of the features of the invention is that the retrieval and distribution server 10 transfers a part of the retrieval results obtained from the Web server 1 as public information to the bulletin board server 6 so as to be opened to an indefinite number of users via the bulletin board server 6.

The transfer of the public information from the retrieval and distribution server 10 to the bulletin board server 6 is carried out according to the bulletin distribution conditions designated by the bulletin management terminal 5. According to an embodiment of the invention, as the bulletin distribution conditions, for example, grouping definition information, a bulletin board address, and distribution time are designated. In this case, the retrieval and distribution server 10 detects overlapping information from retrieval results of a plurality of users designated by the grouping definition information and transfers it as public information to the bulletin board server 6.

Another the feature of the invention is that parameter information for determining the degree of importance of the retrieval result is designated by each user in association with his or her retrieval conditions, the retrieval and distribution server 10 evaluates information retrieved from the Web server 1 in accordance with the importance judging parameter information, and distributes the information to which indication of the degree of importance is added to the user terminal as a requester.

In order to realize the above function, the retrieval and distribution server 10 of the invention is provided with a retrieval and distribution conditions table 21 for storing retrieval reservation information designated by each user terminal 4, an importance judging information table 23 for storing an importance judging parameter, a bulletin distribution condition table 25 for storing a bulletin distribution condition designated by the bulletin management terminal 5, and a retrieved data file 27 for storing a retrieval result obtained from the Web server 1.

The retrieval and distribution server 10 further includes: a retrieval and distribution conditions input routine 100 for receiving a retrieval reservation from each user terminal 4; a bulletin distribution condition input routine 120 for receiving bulletin distribution conditions from the bulletin management terminal 5; a main control routine 130 for executing a retrieval processing and a retrieved data distribution processing at time designated by the retrieval conditions and the bulletin distribution conditions; a retrieval routine 150, a bulletin distribution routine 170, and a retrieved data distribution routine 190 which are activated by the main control routine 130; and an importance judging routine 160 activated by the retrieval routine 150. By executing these programs, a reservation retrieving function, a retrieval result distributing function, and a retrieval result bulletin function are realized.

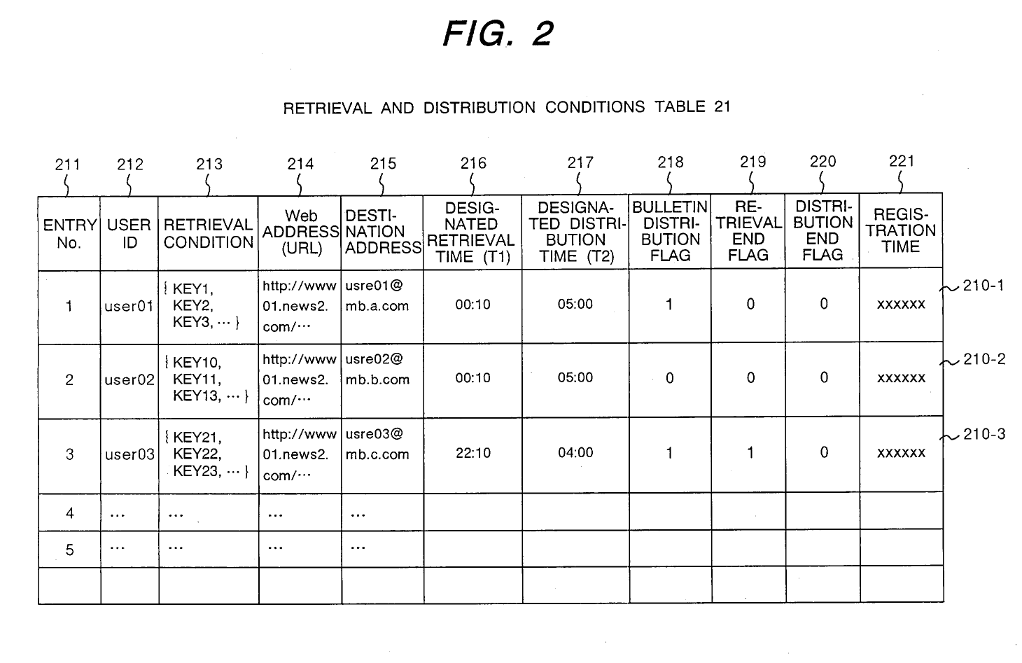

FIG. 2 shows an example of the structure of the retrieval and distribution conditions table 21.

The retrieval and distribution conditions table 21 is constructed by a plurality of retrieval and distribution condition entries 210-i (i=1, 2, . . . ) identified by entry numbers 211. Each retrieval and distribution condition entry 210-i indicates user ID 212, retrieval conditions 213, Web address (URL) 214, destination address (mail address of the requester user) 215, designated retrieval time (T1) 216, designated distribution time (T2) 217, a bulletin distribution flag 218 indicating whether the contents of document information published by the bulletin board server 6 should be distributed to the user or not, a retrieval end flag 219 indicating whether retrieval has been completed or not, a distribution end flag 220 indicating whether distribution of the retrieval result to the requester user terminal has been completed or not, and registration time 221 of the retrieval reservation.

The retrieval condition 213 specifies, for example, information to be retrieved by a logical expression of a plurality of keywords. In the Web address (URL) 214, URL indicative of a storage location of the information to be retrieved is described.

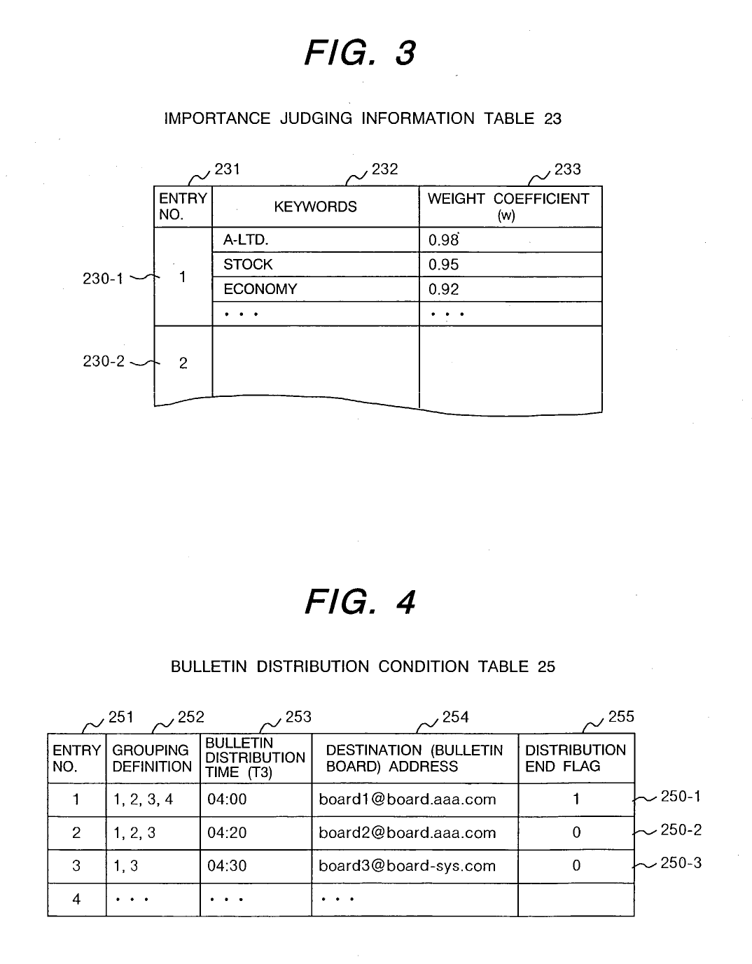

FIG. 3 shows an example of the structure of the importance judging information table 23.

The importance judging information table 23 is constructed by a plurality of judging information entries 230-i (i=1, 2, . . . ) corresponding to the entries 210-i registered in the retrieval and distribution conditions table 21. Each of the judging information entries 230-i indicates entry number 231, keywords 232, and a weight coefficient (w) 233 assigned to the keyword.

For example, the entry number 231 of the i-th entry 230-i in the importance judging information table 23 corresponds to the entry number 211 of the i-th entry 210-i in the retrieval and distribution conditions table 21. As the keywords 232, a part or all of a keyword group described in the retrieval conditions 213 of the i-th entry 210-i in the retrieval and distribution conditions table 21 are registered. In some cases, a keyword which is not in the retrieval conditions is designated. For each of the keywords, the value of the weight coefficient 233 as an importance judging parameter is defined. The degree of importance of retrieved information is calculated, for example, as a value obtained by converting the number of appearing times of the keyword 232 in each document by a weight coefficient value.

FIG. 4 shows an example of the structure of the bulletin distribution condition table 25.

The bulletin distribution condition table 25 is constructed by a plurality of bulletin distribution condition entries 250-j (j=1, 2, . . . ) having entry numbers 251. Each bulletin distribution condition entry 250-j includes grouping definition 252 indicative of a group of a plurality of users or retrieval conditions to be judged, bulletin distribution time 253 indicative of the posting time of public information to the bulletin board server, destination (bulletin board) address 254, and a distribution end flag 255 indicating whether distribution of the public information to the bulletin board has been finished or not.

In the embodiment, the plurality of entry numbers 211 registered in the retrieval and distribution table 21 are grouped by the grouping definition 252, and overlapping information is detected from a set of retrieval results of each group and used as public information. For example, by grouping retrieval requesting users every section in a company, preparing a bulletin board for each section in the bulletin board server 6, and designating an e-mail address assigned to each bulletin board as a destination (bulletin board) address 254, relatively general information which is common to two or more retrieval requesting users in the same section can be opened to an indefinite number of members in the section through the bulletin board assigned for the section.

The retrieval and distribution server 10 monitors the retrieval and distribution conditions table 21 shown in FIG. 2, detects an entry of which designated retrieval time 216 has come, and executes Web retrieval according to the retrieval conditions 213. After completion of the Web retrieval, the entry number of the retrieval and distribution condition, retrieval end time, the number of information items retrieved, and the contents of the information are stored into the retrieved data file 27.

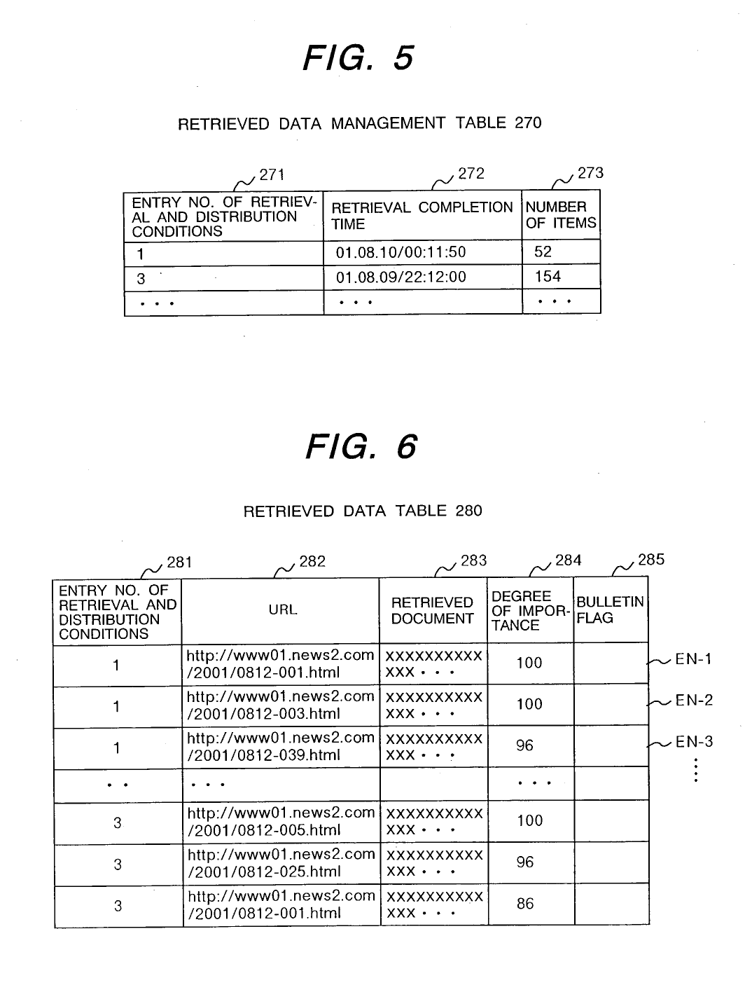

In the retrieved data file 27, for example, a retrieved data management table 270 shown in FIG. 5 and a retrieval data table 280 shown in FIG. 6 are formed.

In the retrieved data management table 270, in correspondence with entry number 271 of retrieval and distribution conditions, retrieval completion time 272 and the number 273 of items of information retrieved are stored. As the entry number 271 of retrieval, the entry number 211 of the retrieval and distribution conditions table 21 shown in FIG. 2 is set.

In the retrieved data table 280, for example, as shown in FIG. 6, a plurality of data entries EN-1, EN-2, EN-3, . . . each including entry number 281 of retrieval and distribution conditions, URL 282, the contents (title) 283 of retrieved document, the degree of importance 284, and a bulletin flag 285 are stored. In the case where “n” pieces of information matching the retrieval conditions indicated by entry number “i” of retrieval and distribution conditions are retrieved, “n” retrieved data entries having the same entry number “i” are stored in the retrieved data table 280.

The degree of importance 284 is automatically calculated by the retrieval and distribution server 10 according to the judging parameters, for example, keywords and weight coefficients, shown in the importance judging information table 23. On completion of the retrieval, the value “0” indicating that the retrieved information has not been posted yet on the bulletin board is set in the bulletin flag 285 of each entry.

The retrieval result stored in the retrieved data table 280 is automatically distributed to the user terminal as the requester indicated by the destination address 215 at the designated distribution time (T2) 217 indicated in the retrieval and distribution conditions table 21.

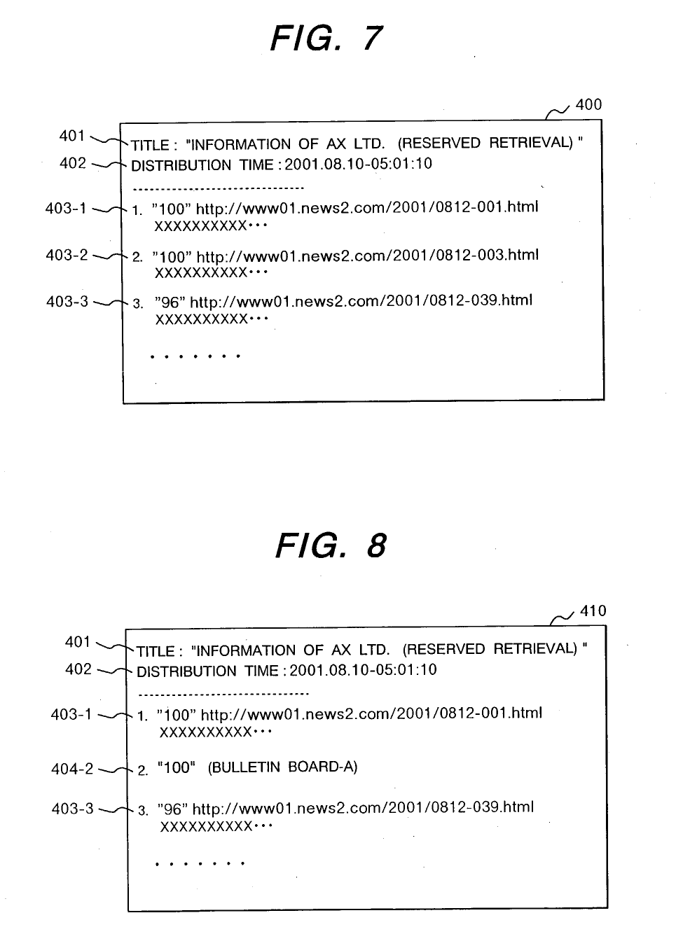

FIGS. 7 and 8 show examples of a distribution message of a retrieval result transmitted from the retrieval and distribution server 10 to the requester user terminal in a form of an e-mail.

FIG. 7 shows a normal type distribution message 400 for notifying the requester user of all contents of retrieved documents. Numeral 401 indicates the title of the message, 402 indicates distribution time, and 403 (403-1, 403-2, . . . ) indicates the contents of the retrieved documents. As a part of the contents of document 403, for example, a tree digits numerical value indicative of the degree of importance, the address (URL) of a provider of the retrieved document information and the contents of the document are offered.

FIG. 8 shows a distribution message 410 of an omission type in which description of the contents of documents posted on a bulletin board is simplified. With respect to the message title 401, distribution time 402, and the contents 403 of a document which is not posted on a bulletin board, the same format as that of the distribution message 400 of the normal type is employed. With respect to a document posted on the bulletin board, for example, as shown by an item 404-2, the degree of importance and the name of the bulletin board are indicated.

The retrieval and distribution server 10 retrieves public information to be posted on the bulletin board in accordance with the bulletin distribution conditions shown in the bulletin distribution condition table 25 among from information registered in the retrieved data table 280 and transfers the retrieved information to the bulletin board server 6.

Specifically, the retrieval and distribution server 10 monitors the bulletin distribution condition table 25, detects an bulletin distribution condition entry 250-j of which bulletin distribution time 253 has come, and retrieves overlapping information in the retrieved data table 280 among from a set of retrieval results of a plurality of users designated by the grouping definition 252 of the entry. The overlapping documents are edited in a message destined to the destination (bulletin board) address 254 and the message is transmitted to the bulletin board server 6 via the LAN 3. The bulletin board server 6 stores the public document information received from the retrieval and distribution server 10 into a file area corresponding to the bulletin board address 254 and offers the information to unspecified users by means of the bulletin board.

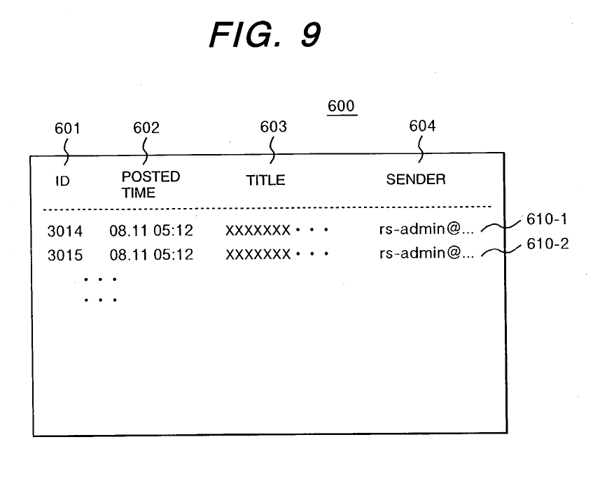

FIG. 9 shows an example of the details of the bulletin board offered by the bulletin board server 6.

In each bulletin board, a plurality of items 610-1, 610-2, . . . each including ID (item number) 601 of the item, posted time 602, title 603, and sender 604 are indicated. The posted time 602 indicates distribution time of the information sent from the retrieval and distribution server 10 to the bulletin board server 6. As the title 603, the head portion of the information is displayed. As the sender 604, the ID of the retrieval and distribution server 10 as a provider of the information is displayed as, for example, “rs-admin@ . . .”.

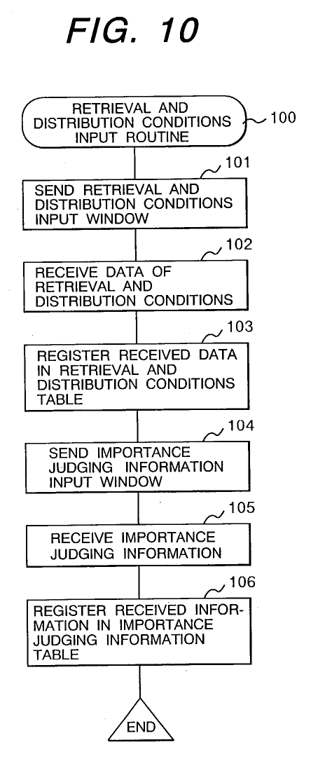

FIG. 10 shows the flowchart of the retrieval and distribution conditions input routine 100 executed by the retrieval and distribution server 10 in response to the reservation request from the user terminal 4.

When the reservation request from the user terminal 4 is received, the retrieval and distribution server 10 transmits an entry screen of the retrieval and distribution conditions to the user terminal as a requester (step 101). The user enters reserved retrieval and distribution condition data such as user ID, retrieval condition, Web address, distribution destination address, designated retrieval time, designated distribution time, bulletin distribution flag, and the like through the condition entry screen displayed on the terminal screen.

Upon receiving the registration retrieval and distribution condition data from the user terminal (102), the retrieval and distribution server 10 generates a new retrieval and distribution condition entry including the received data, and adds the new entry to the retrieval and distribution conditions table (103). In this case, the initial value “0” is automatically set in the retrieval end flag 219 and the distribution end flag 220, and the date and time of generation of the retrieval condition entry are automatically set in the registration time 221.

After addition of the entry to the retrieval and distribution conditions table 21, the retrieval and distribution server 10 transmits the entry screen of the importance judging information to the user terminal 4 (104). The entry screen of the importance judging information includes, for example, an input area of the weight coefficient of each keyword designated as a retrieval condition and an input area of new keywords and weight coefficients other than the retrieval conditions. The user enters importance judging information (the relation between a keyword and a weight coefficient) through the entry screen of the importance judging information displayed on the terminal screen.

When the importance judging information is received from the user terminal (105), the retrieval and distribution server 10 generates a new entry defining the relation between the keyword and the coefficients designated by the user, registers the new entry into the importance judging information table 23 (106), and finishes the routine.

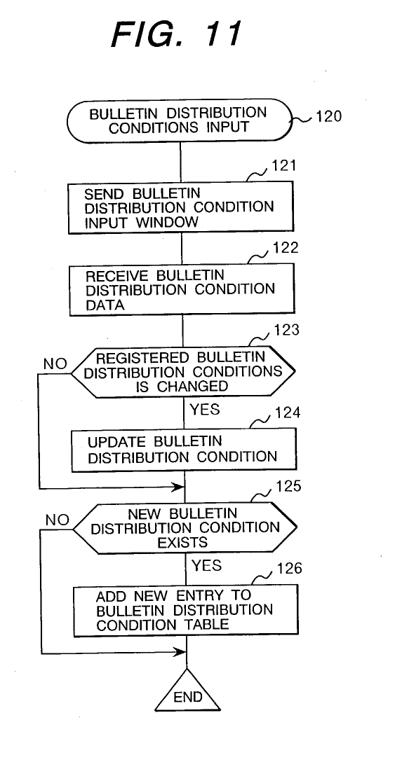

FIG. 11 shows the flowchart of the bulletin distribution condition input routine 120 executed by the retrieval and distribution server 10 in response to a bulletin distribution registration request from the bulletin management terminal 5.

When the bulletin distribution registration request is received from the bulletin management terminal 5, the retrieval and distribution server 10 generates a bulletin distribution condition entry screen including data of main items registered in the retrieval and distribution conditions table 21 and data registered in the bulletin distribution condition table 25, and transmits the bulletin distribution condition entry screen to the terminal 5 as a requester (step 121).

A bulletin manager enters new bulletin distribution conditions to the bulletin distribution condition table 25 and corrects registered bulletin distribution conditions with reference to the bulletin distribution condition entry screen displayed on the terminal screen. For example, by referring to the present state of the bulletin distribution condition table 25 and the user ID, retrieval conditions, Web address, distribution destination address, and registration time registered in the retrieval and distribution conditions table 21 displayed on the bulletin distribution condition entry screen, the bulletin manager determines whether inputting of the bulletin distribution condition, is necessary or not with respect to the entry newly added to the retrieval and distribution conditions table 21. If there is entry number of retrieval conditions to be added to the grouping definition 252 of one of the registered bulletin distribution condition entries, the registered bulletin distribution condition is corrected. If there are retrieval condition entry numbers to form a new grouping definition, a new bulletin distribution condition entry is added.

When bulletin distribution condition data is received from the bulletin management terminal 5 (122), the retrieval and distribution server 10 determines whether the registered bulletin distribution condition has been changed or not (123) and, if YES, corrects the entry in the bulletin distribution condition table 25 (124). Subsequently, the retrieval and distribution server 10 determines the presence or absence of a new bulletin distribution condition (125) and, if there is a new bulletin distribution condition, adds a new entry to the bulletin distribution condition table 25 (126).

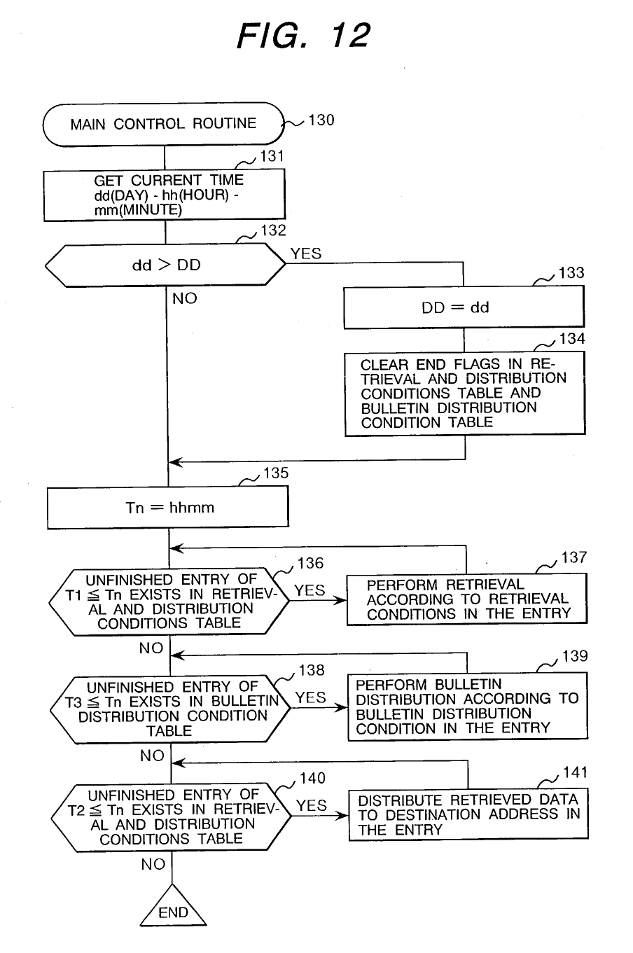

FIG. 12 shows a flowchart of a main control routine 130 periodically executed by the retrieval and distribution server 10 in order to perform Web retrieval and distribution of a retrieval result in accordance with the retrieval and distribution condition and the bulletin-distribution condition.

The main control routine 130 is periodically executed in response to, for example, timer interruption. First, the value ddhhmm (date, hour, minute) of the present time indicated by a clock is obtained (step 131) and the present date dd is compared with a previous value DD which has been set (132). In the case where the date has been changed, the present date dd is stored as a new value of DD (133) and end flags (the retrieval end flag 219, and distribution end flag 220 and 255) of each entry registered in the retrieval and distribution conditions table 21 and the bulletin distribution condition table 25 are cleared (134).

Next, after setting the current time hhmm to a time parameter Tn (135), an entry 210-j of which retrieval designation time T1 has come and which,has not been retrieved yet (entry of which retrieval end flag 219 is “0” when T1≦Tn) is selected from the retrieval and distribution conditions table 21 (136). When the entry 210-j of which retrieval designation time T1 has come and which has not been retrieved yet is found, a Web retrieval processing is executed in accordance with the retrieval condition 213 and the Web address 214 indicated by the entry (137). After the Web retrieval processing according to the retrieval condition is finished, the program sequence returns to step 136 and similar operations are repeated.

After completion of the determining step (136) with respect to all of entries in the retrieval and distribution condition table 21, an entry 250-p which has reached bulletin distribution time T3 and has not been posted yet (entry of which distribution end flag 255 is “0” when T3≦Tn) is selected from the bulletin distribution table 25 (138). When the entry 250-p which has reached the bulletin distribution time T3 and has not been posted yet is found, a bulletin distribution processing is performed in accordance with the bulletin distribution conditions indicated by the entry (139). After the bulletin distribution processing under the bulletin distribution conditions is completed, the program sequence returns to step 138 and similar operations are repeated.

When the determining step (138) is completed with respect to all of the entries in the bulletin distribution condition table 25, an entry 210-q which has reached the distribution designated time T2 and has not been distributed yet (entry of which distribution end flag 220 is “0” when T2≦Tn) is selected from the retrieval and distribution conditions table 21 (140). When the entry 210-q of which designated retrieval time T2 has come and which has not been distributed yet is found, a distribution processing of the retrieval result to the user terminal indicated by the destination address 215 of the entry is executed (141). After the distribution processing (141), the program sequence returns to step 140 and similar operations are repeated.

When the determining step for distributing the retrieval result is completed on all of the entries of the retrieval and distribution condition table 21 (140), the routine is finished. Although the main control routine is periodically executed by timer interruption in the embodiment, it is also possible to return to the first step 131 when the determining step (140) is completed.

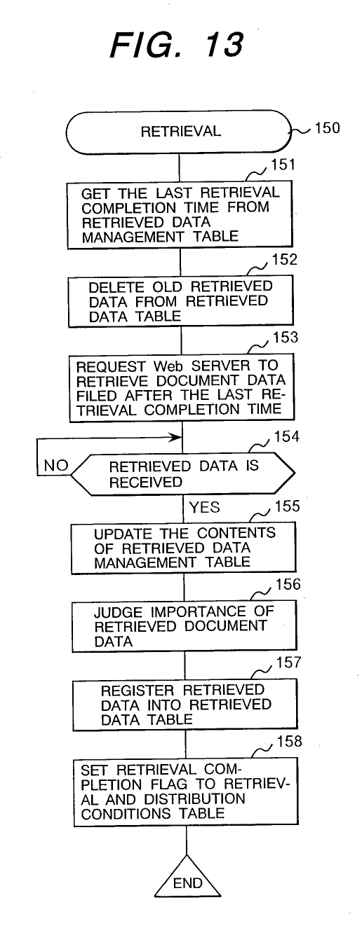

FIG. 13 shows the detailed flowchart of a retrieval routine 150 executed in step 137 in FIG. 12.

In the retrieval routine 150, the retrieval completion time 272 corresponding to the entry number of the entry 210-j which has not been retrieved and which indicates the retrieval condition of this time is obtained from the retrieved data management table 270 shown in FIG. 5 (step 151). Next, retrieved data corresponding to the entry number of the entry 210-j is deleted from the retrieved data table 280 shown in FIG. 6 (152) and, after that, subjecting such document information generated after the last retrieval completion time 272 as the objects of retrieval, a Web retrieval request message is generated in accordance with the retrieval condition 213 and the Web address 214 indicated by the retrieval condition entry 210-j, and the message is transmitted to the Internet 2 (153).

When the retrieval result is received from the Web server (154), the management data of the corresponding entry (the retrieval completion time 272 and the number 273 of retrieved items) in the retrieval data management table 270 is updated (155) and the degree of importance of each retrieved information item is judged (156). After that, the retrieval result and the degree of importance are registered in the retrieved data table 280 shown in FIG. 6 (157), “1” is set in the retrieval end flag 220 in the retrieval and distribution condition entry 210-j in the retrieval and distribution conditions table 21 (158), and the routine is finished.

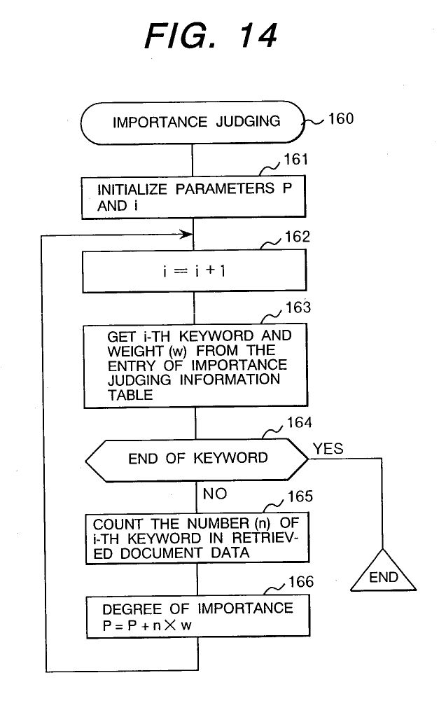

FIG. 14 shows the detailed flowchart of an importance judging routine 160 executed for each information item in step 156 in FIG. 13.

In the importance judging routine 160, values of a parameter “P” indicative of the value of the degree of importance and a parameter “i” for reading out a keyword from the importance judging information table 23 are initialized (step 161) and the value of the parameter “i” is incremented (162). After that, the i-th keyword and a weight coefficient (w) corresponding to the entry number of the retrieval condition entry 210-j are obtained from the importance judging information table 23 (163), and the number “n” of the i-th keywords included in a retrieval document to be judged is counted (165). Then, the value of the degree of importance “P=P+n×w” is calculated (166) and the program sequence returns to step 162.

With respect to all of keywords corresponding to the retrieval condition entry 210-j registered in the importance judging information table 23, the steps 162 to 166 are repeated (164), thereby obtaining the value P of the degree of importance for one retrieval document.

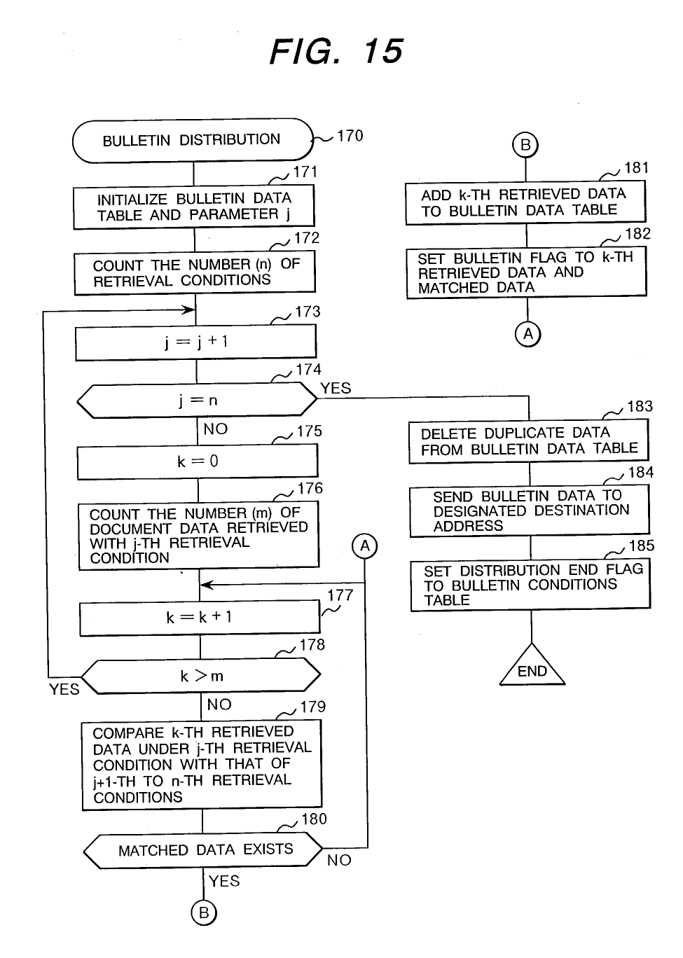

FIG. 15 shows the detailed flow chart of a bulletin distribution routine 170 executed in step 139 in FIG. 12. In the embodiment, in a set of retrieval results by “n” users (“n” retrieval conditions) designated by the grouping definition in the bulletin distribution condition table 25, first, the retrieval result of the first user as an object to be determined is sequentially checked with retrieval results of other users and overlapping information common to the other users is sequentially registered into a bulletin data table. While sequentially switching the user like a second user, a third user, . . . , by repeating similar process on the retrieval result to be determined, retrieved information common to a plurality of users is sequentially registered in the bulletin distribution table in a manner such that overlapped registration of the same information is allowed. The overlapping information registered in the bulletin distribution table is deleted after completion of collation with the retrieval results of all of the users.

In the bulletin distribution routine 170, first, the bulletin distribution table (not shown) and the value of a user designation parameter “j” for specifying a user to be judged are initialized (step 171) and, by referring to the grouping definition 252 of the entry 250-p which has not be posted on the bulletin board yet, the number “n” of retrieval condition entries (the number of users) to be judged is counted (172). Next, the value of the parameter “j” is incremented (173) and the value of “j” is compared with the value of “n” (174). If “j” is not equal to “n”, the value of a parameter “k” is cleared. This parameter “k” is used to specify an information item to be collated with the other among from retrieval results in the retrieved data table 280 which are matching the j-th retrieval condition in the grouping definition (175). After that, the number “m” of entries of retrieved information matching the j-th retrieval condition in the retrieved data table 280 is counted (176).

The value of the parameter “k” is incremented (177) and compared with the number “m” of entries (178) If the relation “k>m” is not satisfied, the k-th information included in the retrieval result matching the j-th retrieval condition is sequentially collated with retrieval results matching other retrieval conditions (the (j+1)-th retrieval condition to the m-th retrieval condition) (179). In the case where information matching the k-th information is not found, the program sequence returns to step 177. When overlapping data matching with the k-th document information exists in the retrieval results according to the other retrieval conditions (180), the k-th data (information item) is added to the bulletin data table (181), “1” is set in the bulletin flag 285 of each of the entry of the k-th data and the entry of the overlapping data in the retrieved data table 280 (182) and the program sequence returns to step 177.

When the value of the parameter “k” incremented in step 177 exceeds the number “m” of entries, the program sequence returns to step 173 where the value of the parameter “j” is incremented, and the above-described operation is repeated on the retrieval result according to the next retrieval condition designated by the grouping definition as an object to be determined.

When the incremented value of the parameter “j” becomes equal to the number “n” of retrieval conditions, the above collation processing among the retrieval results is completed. In this case, in step 183, the overlapping data in the bulletin data table is deleted, the document data remained in the bulletin data table are transmitted to the destination address 254 of the bulletin distribution condition entry 250-p (184), “1” is set in the bulletin end flag 255 in the bulletin condition entry 250-p (185), and the routine is finished.

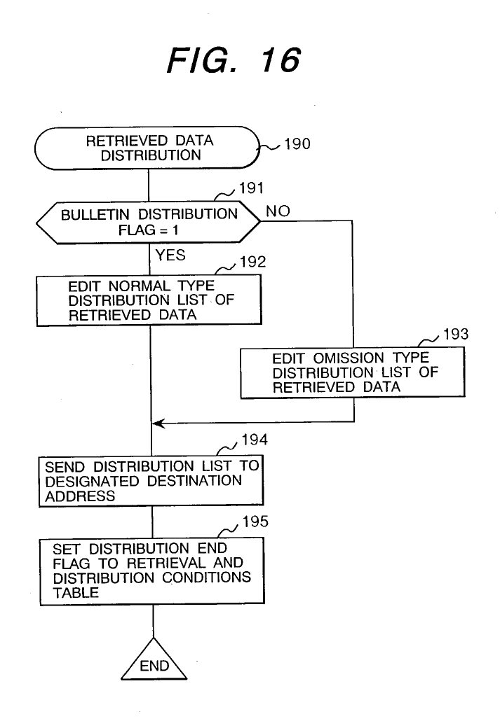

FIG. 16 shows the detailed flowchart of a routine 190 of distributing retrieved data to the user terminal as a requester, which is executed in step 141 in FIG. 12.

In the retrieved data distribution routine 190, the bulletin distribution flag 218 in the entry 210-p which has not be distributed yet is checked (step 191). In the case where the bulletin data distribution flag 218 is “1”, retrieval results (URL 282 and retrieved document 283) corresponding to the entry number of the entry 210-q are read out from the retrieved data table 280 and, for example, a normal-type distribution list shown in FIG. 7 is generated (192). In the case where the bulletin data distribution flag 218 is “0”, a retrieval result read out from the retrieved data table 280 is edited to, for example, an omission-type distribution list shown in FIG. 8 (193).

After that, the distribution list is transmitted in the form of an e-mail to the user terminal indicated by the destination address 215 in the entry 210-q which has not been distributed yet (194), “1” is set in the distribution end flag 220 in the entry 210-q (195) and the routine is finished.

Although the contents of the retrieval and distribution conditions and the user which are actually registered are checked before setting the bulletin distribution conditions in the foregoing embodiment, the bulletin distribution condition may be set in other ways. For example, an office organization table in which user IDs or destination addresses are preliminarily grouped section by section is prepared. When a new retrieval and distribution condition entry is generated, a group related to the retrieval and distribution condition entry is specified by referring to the office organization table, and the entry number of the retrieval and distribution condition entry is added to bulletin distribution conditions for each group already registered in the bulletin distribution condition table.

In the embodiment, retrieved information common to two or more users is selected as public or open information and posted on the bulletin board. As the reference of selecting open data, any of methods other than that of the embodiment can be also employed. For example, in order to limit the number of data to be posted, open data may be selected among from retrieved data common to three or more users.

As obviously understood from the embodiments, according to the information retrieval and distribution system of the invention, the latest information common to a group can be always provided not only to a user who has requested for retrieval and distribution but also to an indefinite number of users. Further, according to the invention, information can be distributed for each user in a form such that information important for the user can be easily identified among from the retrieved data.

What is claimed is:

1. An information retrieval and distribution method using a computer, wherein said computer reads out information associating a storage location of information prestored in a storage, a retrieval condition of the information, and a distribution condition of the information, the method comprising the steps of:
retrieving information from the storage location of said information on the basis of the retrieval condition of the information associated with the storage location of said information, and
displaying a result of retrieving said information on an electronic bulletin board on the basis of the distribution condition of the information associated with the storage location of said information.

2. The information retrieval and distribution method according to claim 1, wherein said information retrieval condition includes at least one of time at which the information is retrieved and a retrieval expression used for retrieving the information.

3. The information retrieval and distribution method according to claim 1, wherein said information distribution condition includes at least one of time at which information is distributed, information regarding a destination of information, and information regarding a user who distributes the information.

4. An information retrieval-distribution system connected to a computer network including a plurality of user terminals and a communication network to which various information providing servers are connected, for accessing said information providing servers instead of said user terminals, comprising:
retrieval and distribution processing means for accepting a request of retrieval and distribution of information from any of said user terminals, retrieving information from any of said information providing servers in accordance with a retrieval condition designated by the user, and distributing the retrieved information to the user terminal as the requester at pre-designated time; and
bulletin information processing means for selecting information to be disclosed in accordance with a predetermined posting condition among from retrieval results based on said retrieval and distribution request and transferring the selected information to an electronic bulletin board system connected in said computer network.

5. The information retrieval-distribution system according to claim 4, wherein said retrieval and distribution processing means executes retrieval of said information at the time which is pre-designated by the user in said retrieval and distribution request.

6. The information retrieval-distribution system according to claim 4, wherein said bulletin information processing means selects overlapping information included in retrieval results of a plurality of users designated as a group by said bulletin conditions as said open information to be disclosed through the bulletin boar system.

7. The information retrieval-distribution system according to claim 5, wherein said bulletin information processing means selects overlapping information included in retrieval results of a plurality of users designated as a group by said bulletin conditions as said open information to be disclosed through the bulletin boar system.

8. The information retrieval-distribution system according to claim 6, wherein said bulletin conditions designate a bulletin board address and posting time, and said bulletin information processing means selects open information among from retrieval results of a plurality of users designated as said group and transfers the selected open information as information to be posted on an electronic bulletin board specified by said bulletin board address to said bulletin board system at the posting time designated by said bulletin conditions.

9. The information retrieval-distribution system according to claim 4, wherein said retrieval and distribution means has means for distributing a retrieval result to the user terminal as the requester in a form in which retrieved information selected as open information by said bulletin information processing means has a simplified content.

10. The information retrieval-distribution system according to claim 5, wherein said retrieval and distribution means has means for distributing a retrieval result to the user terminal as the requester in a form in which retrieved information selected as open information by said bulletin information processing means has a simplified content.

11. The information retrieval-distribution system according to claim 4, wherein said retrieval and distribution means has means for distributing a retrieval result to the user terminal as the requester in a form in which a message indicating that the information is posted on a bulletin board is added in place of the contents of the information selected as open information by said bulletin information processing means.

12. The information retrieval and distribution system according to claim 4, wherein said retrieval and distribution means stores importance judging information of retrieved information in association with said retrieval and distribution conditions and has means for determining the degree of importance of each information item retrieved according to said retrieval and distribution condition in accordance with said importance judging information and distributing the retrieved information to the user terminal as a requester in a form in which a result of judging the degree of importance is added.
